(19) United States
(12) Patent Application Publication
(10) Pub. No.: US 2022/0293923 A1
(43) Pub. Date: Sep. 15, 2022

(54) NEGATIVE ELECTRODE, SECONDARY BATTERY, AND SOLID-STATE SECONDARY BATTERY

(71) Applicant: SEMICONDUCTOR ENERGY LABORATORY CO., LTD., Sagamihara-shi, Kanagawa-ken (JP)

(72) Inventors: Kazutaka KURIKI, Ebina, Kanagawa (JP); Yumiko YONEDA, Isehara, Kanagawa (JP); Hiroshi KADOMA, Sagamihara, Kanagawa (JP); Kaori OGITA, Isehara, Kanagawa (JP); Shunpei YAMAZAKI, Setagaya, Tokyo (JP)

(21) Appl. No.: 17/632,358

(22) PCT Filed: Jul. 29, 2020
(86) PCT No.: PCT/IB2020/057126

§ 371 Date: Feb. 2, 2022

(30) Foreign Application Priority Data
Aug. 9, 2019 (JP) 2019-147278
Oct. 18, 2019 (JP) 2019-191144

(51) Int. Cl. H01M 4/38; H01M 4/36; H01M 10/0525

(52) U.S. Cl. CPC H01M 4/386; H01M 4/366; H01M 10/0525; H01M 2004/027

(57) ABSTRACT

A highly reliable solid-state secondary battery with improved cycle performance, reliability, or safety is provided. A negative electrode includes, over a negative electrode current collector, n negative electrode active material layers (n is an integer greater than or equal to 2) and n−1 separation layers. The negative electrode active material layers and the separation layers are alternately stacked. The thickness of the negative electrode active material is greater than or equal to 20 nm and less than or equal to 100 nm. The separation layers each include titanium. The separation layer preferably includes titanium (Ti), titanium nitride (TiN), or titanium oxynitride (TiOxNy, 0<x<2, 0<y<1). With the negative electrode having such a structure, the expansion of each negative electrode active material layer can be reduced. Accordingly, the negative electrode that has high capacity and hardly causes a crack or a breakage can be obtained.

### TECHNICAL FIELD

One embodiment of the present invention relates to an object, a method, or a manufacturing method. Alternatively, the present invention relates to a process, a machine, manufacture, or a composition (composition of matter). One embodiment of the present invention relates to a semiconductor device, a display device, a light-emitting device, a power storage device, a lighting device, an electronic device, or a forming method thereof.

Note that electronic devices in this specification generally mean devices including power storage devices, and electro-optical devices including power storage devices, information terminal devices including power storage devices, and the like are all electronic devices.

### BACKGROUND ART

In recent years, a variety of power storage devices such as lithium-ion secondary batteries, lithium-ion capacitors, all-solid batteries, and air batteries have been actively developed. In particular, demand for lithium-ion secondary batteries with high output and high capacity has rapidly grown with the development of the semiconductor industry. The lithium-ion secondary batteries are essential as rechargeable energy supply sources for today's information society.

Thus, improvement of a negative electrode has been studied to increase the capacity and the cycle performance of a lithium-ion secondary battery and the like.

Use of Si (silicon) for a negative electrode active material has been widely researched because Si per atom has higher capability of occluding lithium ions than graphite per atom and the like. For example, Patent Document 1 discloses a lithium-ion secondary battery using a silicon composite in which silicon oxide is covered with carbon by thermal CVD as a negative electrode active material.

A lithium ion secondary battery using liquid such as an organic solvent as a transmission medium (hereinafter, referred to as an electrolyte) of lithium ions serving as carrier ions is widely used. However, a secondary battery using liquid as an electrolyte (hereinafter, also referred to as an electrolyte solution) has problems such as the operable temperature range, decomposition reaction of an electrolyte solution by a potential to be used, and liquid leakage to the outside of the secondary battery since the secondary battery uses liquid. In addition, a secondary battery using liquid as an electrolyte has a risk of ignition due to liquid leakage.

As a secondary battery using no liquid, a power storage device using a solid electrolyte, which is called a solid-state secondary battery, is known. For example, Patent Document 2 is disclosed.

### REFERENCES

### Patent Documents

[Patent Document 1] Japanese Published Patent Application No. 2004-047404
[Patent Document 2] U.S. Pat. No. 8,404,001

### SUMMARY OF THE INVENTION

### Problems to be Solved by the Invention

As described above, negative electrode active materials including Si covered with carbon have been researched. However, such negative electrode active materials have yet to sufficiently exhibit the performance required for secondary batteries. It is known that the negative electrode active material including Si increases in volume by occluding lithium ions. This expansion might have an adverse effect on the characteristics of a secondary battery, such as generation of a crack or a break in the negative electrode.

There is room for improvements in a variety of aspects such as charge and discharge characteristics, cycle performance, reliability, safety, and costs of solid-state secondary batteries.

In view of the above, an object of one embodiment of the present invention is to provide a negative electrode with high charge and discharge capacity. Another object of one embodiment of the present invention is to provide a negative electrode with excellent cycle performance. Another object of one embodiment of the present invention is to provide a novel negative electrode. Another embodiment of the present invention is to provide a solid-state secondary battery with high charge and discharge capacity. Another object of one embodiment of the present invention is to provide a solid-state secondary battery with excellent cycle performance. An object of one embodiment of the present invention is to provide a novel power storage device.

Note that the description of these objects does not preclude the existence of other objects. One embodiment of the present invention does not have to achieve all these objects. Other objects can be derived from the description of the specification, the drawings, and the claims.

### Means for Solving the Problems

One embodiment of the present invention is a negative electrode including, over a negative electrode current collector layer, n negative electrode active material layers (n is an integer greater than or equal to 2) and n−1 separation layers. The negative electrode active material layers and the separation layers are alternately stacked. The thickness of each negative electrode active material layer is greater than or equal to 20 nm and less than 100 nm. The separation layers each include a Group 4 element.

Another embodiment of the present invention is a negative electrode including, over a negative electrode current collector layer, n negative electrode active material layers (n is an integer greater than or equal to 2) and n−1 separation layers. The negative electrode active material layers and the separation layers are alternately stacked. The thickness of the negative electrode active material layers is greater than or equal to 20 nm and less than 100 nm. The separation layers each include titanium nitride, titanium oxide, or titanium oxynitride.

In the above structure, a first negative electrode active material layer is preferably in contact with the negative electrode current collector layer.

In the above structure, the separation layer is preferably in contact with the negative electrode active material layer.

In the above structure, the thickness of the separation layer is preferably greater than or equal to 5 nm and less than or equal to 40 nm.

In the above structure, a first layer over an n-th negative electrode active material layer is preferably included, and further preferably, the first layer includes Ti.

In the above structure, the negative electrode active material layers preferably each include Si.

In the above structure, the separation layers preferably each have a layered structure.

### Effect of the Invention

According to one embodiment of the present invention, a negative electrode with high charge and discharge capacity can be provided. According to another embodiment of the present invention, a negative electrode with excellent cycle performance can be provided. According to another embodiment of the present invention, a novel negative electrode can be provided. According to another embodiment of the present invention, a solid-state secondary battery with high charge and discharge capacity can be provided. According to another embodiment of the present invention, a solid-state secondary battery with excellent cycle performance can be provided. According to another embodiment of the present invention, a novel power storage device can be provided.

In the thin-film-type solid-state secondary battery, an increase in the number of sets of stacked layers each of which includes a positive electrode active material layer, a solid electrolyte layer, and a negative electrode active material layer can lead to multilayer stacking in series or parallel connection and an increase in capacity.

The capacity of the thin-film-type solid-state secondary battery can also be made higher by an increase in the area.

Furthermore, by a separation transfer technology, bending into a desired size can be performed after the area is increased.

### BRIEF DESCRIPTION OF THE DRAWINGS

FIG. 1A is an example of a cross-sectional view of a secondary battery of one embodiment of the present invention. FIG. 1B is a cross-sectional view of a conventional negative electrode active material layer.

FIG. 2A to FIG. 2D are cross-sectional views illustrating embodiments of the present invention.

FIG. 3A to FIG. 3D are cross-sectional views illustrating embodiments of the present invention.

FIG. 4A is a top view illustrating one embodiment of the present invention. FIG. 4B and FIG. 4C are cross-sectional views illustrating embodiments of the present invention.

FIG. 5 is a diagram showing a manufacturing flow of a solid-state secondary battery of one embodiment of the present invention.

FIG. 6A is a top view illustrating one embodiment of the present invention. FIG. 6B is a cross-sectional view illustrating one embodiment of the present invention.

FIG. 7 is a cross-sectional view illustrating one embodiment of the present invention.

FIG. 8A is a perspective view illustrating an example of a battery cell of one embodiment of the present invention. FIG. 8B is a perspective view of a circuit of one embodiment of the present invention. FIG. 8C is a perspective view of the battery cell and the circuit of one embodiment of the present invention, which overlap with each other.

FIG. 9A is a perspective view illustrating an example of a battery cell of one embodiment of the present invention. FIG. 9B is a perspective view of a circuit.

FIG. 9C and FIG. 9D are perspective views of the battery cell and the circuit of one embodiment of the present invention, which overlap with each other.

FIG. 10A is a perspective view of a battery cell. FIG. 10B is a diagram illustrating an example of an electronic device.

FIG. 11 is a diagram illustrating examples of electronic devices of one embodiment of the present invention.

FIG. 12A to FIG. 12C are diagrams illustrating examples of electronic devices of one embodiment of the present invention.

FIG. 13A to FIG. 13D are diagrams illustrating examples of electronic devices of one embodiment of the present invention.

FIG. 14A is a schematic diagram of an electronic device which is one embodiment of the present invention. FIG. 14B is a diagram illustrating part of a system and FIG. 14C is an example of a perspective view of a portable data terminal used with the system of one embodiment of the present invention.

FIG. 15A to FIG. 15C are diagrams illustrating structures of samples according to an example.

FIG. 16 shows cycle performances according to an example.

FIG. 17A and FIG. 17B are cross-sectional TEM images according to an example.

FIG. 18A and FIG. 18B are cross-sectional TEM images according to an example.

FIG. 19 is a diagram illustrating a sample structure according to an example.

FIG. 20A to FIG. 20C are diagrams illustrating the state of the sample after charging and discharging according to an example.

### MODE FOR CARRYING OUT THE INVENTION

Embodiments of the present invention are described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

Note that ordinal numbers such as “first”, “second”, and “third” in this specification and the like are used in order to avoid confusion among components. Thus, the ordinal numbers do not limit the number of components. In addition, the ordinal numbers do not limit the order of components. In this specification and the like, for example, a “first” component in one embodiment can be referred to as a “second” component in other embodiments or the scope of claims. Furthermore, in this specification and the like, for example, a “first” component in one embodiment can be omitted in other embodiments or the scope of claims.

Note that in the drawings, the same elements, elements having similar functions, elements formed of the same material, elements formed at the same time, or the like are sometimes denoted by the same reference numerals, and repeated description thereof is omitted in some cases. The same elements, elements having similar functions, elements formed of the same material, elements formed at the same time, and the like are represented by the same hatch pattern and the reference numerals for such elements are omitted in some cases.

In addition, in this specification and the like, charging refers to transfer of conductive ions (lithium ions in the case of a lithium-ion secondary battery) from a positive electrode to a negative electrode in a battery and transfer of electrons from a negative electrode to a positive electrode in an external circuit. Charging of a positive electrode active material refers to extraction of conductive ions, and charging of a negative electrode active material refers to insertion of conductive ions. The description below is for the case where the conduction ions are lithium ions.

### Embodiment 1

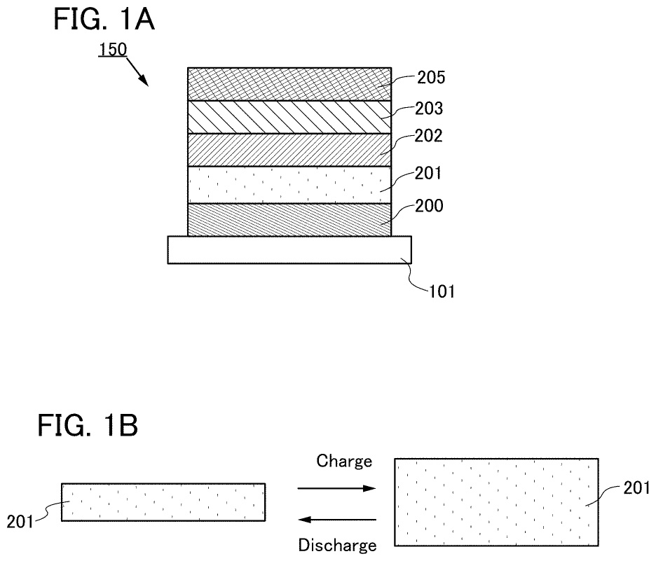

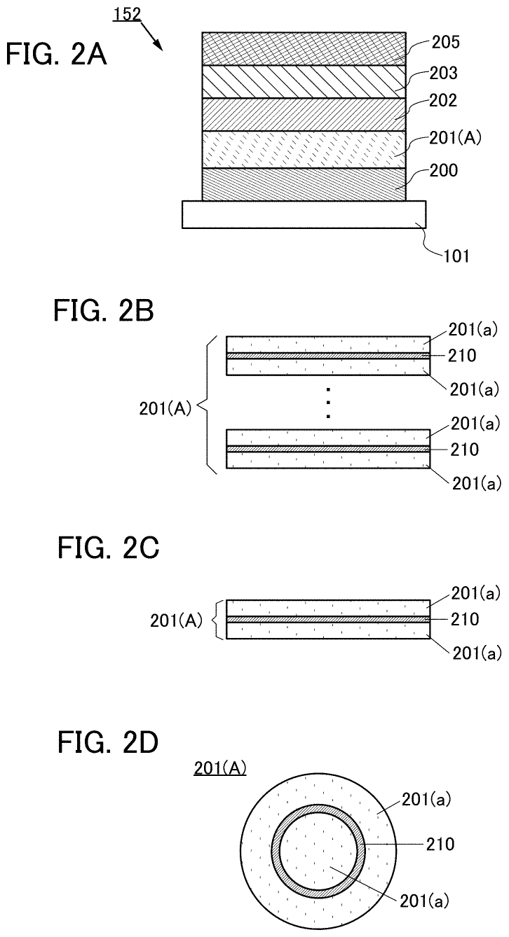

A negative electrode and a secondary battery of one embodiment of the present invention are described with reference to FIG. 1A, FIG. 2A, and FIG. 2B. Note that in this specification, the negative electrode includes at least a negative electrode current collector and a negative electrode active material layer.

In a secondary battery 150 illustrated in FIG. 1A, a negative electrode current collector layer 200, a negative electrode active material layer 201, a solid electrolyte layer 202, a positive electrode active material layer 203, and a positive electrode current collector layer 205 are stacked in this order over a substrate 101. Note that the stacking order may be reversed. Specifically, the positive electrode current collector layer 205, the positive electrode active material layer 203, the solid electrolyte layer 202, the negative electrode active material layer 201, and the negative electrode current collector layer 200 may be stacked in this order over the substrate 101.

Examples of a substrate that can be used as the substrate 101 include a ceramic substrate, a glass substrate, a plastic substrate, a silicon substrate, and a metal substrate.

As materials of the negative electrode current collector layer 200 and the positive electrode current collector layer 205, one or more kinds of conductive materials selected from Al, Ti, Cu, Au, Cr, W, Mo, Ni, Ag, and the like are used. As a deposition method, a sputtering method, an evaporation method, or the like can be used. In a sputtering method, with use of a metal mask, film deposition can be selectively performed. A conductive film may be patterned by being selectively removed by dry etching or wet etching using a resist mask or the like. A plurality of materials may be stacked to form the negative electrode current collector layer 200 and the positive electrode current collector layer 205.

The positive electrode active material layer 203 can be deposited by a sputtering method using a sputtering target including a lithium cobalt oxide (e.g., LiCoO₂, LiCo₂O₄, Li1, 2CoO2, or the like) as its main component, a sputtering target including a lithium manganese oxide (e.g., LiMnO₂, LiMn₂O₄, or the like) as its main component, or a lithium nickel oxide (e.g., LiNiO₂, LiNi₂O₄, or the like). A lithium manganese cobalt oxide (e.g., LiMnCoO₄, Li₂MnCoO₄, or the like), a ternary material of nickel-cobalt-manganese (e.g., LiNi_{1/3}Mn_{1/3}Co_{1/3}O₂: NCM), a ternary material of nickel-cobalt-aluminum (e.g., LiNi_{0.8}Co_{0.15}Al_{0.05}O₂: NCA), or the like can be used. In the above-described material, lithium ions are extracted at the time of charging and lithium ions are accumulated at the time of discharging.

For the negative electrode active material layer 201, a film containing silicon as a main component, a film containing carbon as a main component, a titanium oxide film, a vanadium oxide film, an indium oxide film, a zinc oxide film, a tin oxide film, a nickel oxide film, or the like which is formed by a sputtering method, a CVD method, or the like can be used. As the film containing silicon as a main component, for example, an n+Si film or a p+Si film obtained by doping with phosphorus or boron by a plasma CVD method may be used. A film of tin, gallium, aluminum, or the like which is alloyed with Li can be used. Alternatively, a metal oxide film of any of these which are alloyed with Li may be used. A Li metal film may also be used as the negative electrode active material layer 201. A lithium titanium oxide (Li₄Ti₅O₁₂, LiTi₂O₄, or the like) may be used; in particular, a film containing silicon is preferable. In the above-described materials, lithium ions are accumulated at the time of charging and lithium ions are extracted at the time of discharging.

FIG. 1B shows the state of a change in the thickness of the negative electrode active material layer 201 due to conventional charging and discharging. At the time of charging, lithium ions are accumulated in the negative electrode, so that the negative electrode active material layer 201 increases in thickness (expands).

Here, the case where silicon is used for the negative electrode active material layer 201 is considered. As described above, silicon can be suitably used as a negative electrode active material because of its capability of occluding a large amount of lithium ions. However, silicon occluding lithium ions expands significantly, which might cause a crack or a breakage in the negative electrode active material layer 201. This degrades battery characteristics, particularly cycle performance.

### Structure Example 1 of Negative Electrode

FIG. 2A is a cross-sectional view of a secondary battery 152 of one embodiment of the present invention. The present inventors have devised the structure of a negative electrode active material layer 201(A) including n (n is an integer greater than or equal to 2) negative electrode active material layers 201(a) and n−1 separation layers 210, in which the separation layers 210 and the negative electrode active material layers are alternately stacked, as illustrated in FIG. 2B. In this structure, an i-th (i is an integer greater than or equal to 1 and less than or equal to n) separation layer is in contact with an i-th negative electrode active material layer. With this structure, the expansion of each negative electrode active material layer 201(a) can be reduced as compared with that of the negative electrode active material layer 201 illustrated in FIG. 1B. Accordingly, the negative electrode active material layer that has high capacity and hardly causes a crack or a breakage can be obtained. Note that FIG. 2C illustrates the negative electrode active material layer 201(A) including two electrode active material layers 201(a) and one separation layer 210.

### [Negative Electrode Active Material Layer 201(A)]

The negative electrode active material layer 201(A) illustrated in FIG. 2A to FIG. 2C and the negative electrode active material layer 201 illustrated in FIG. 1A and FIG. 1B preferably each have capacity higher than or equal to the capacity for lithium ions used in the positive electrode active material layer 203. Hence, when the negative electrode active material layer is only one layer like the negative electrode active material layer 201 illustrated in FIG. 1B, the negative electrode active material layer might increase in thickness to ensure the capacity.

The negative electrode active material layer expands by accumulating lithium ions. It is known that, for example, silicon at the time of full charging expands approximately four times as much as that at the time of discharging. Accordingly, if the thickness of the negative electrode active material layer at the time of discharging is too large, the thickness difference between the time of discharging and the time of charging becomes significant large. For example, in the case where the thickness of the negative electrode active material layer is 200 nm at the time of discharging, the thickness of the negative electrode active material layer becomes approximately 800 nm at the time of full charging; that is, the thickness difference between the time of discharging and the time of full charging is as much as approximately 600 nm. This suggests a concern about the above-described adverse effects such as the crack or breakage in the negative electrode active material layer 201. By contrast, in the case where the thickness of the negative electrode active material layer is 20 nm at the time of discharging, the thickness of the negative electrode active material layer 201 becomes approximately 80 nm at the time of full charging; that is, the thickness difference between the time of discharging and the time of full charging is approximately 60 nm. In this case, the crack, breakage, or the like is probably unlikely to occur in the negative electrode active material layer 201.

In the case where silicon is used as the negative electrode active material, the capacity per weight becomes closer to the theoretical capacity as the thickness is smaller. In other words, the capacity per weight of silicon is increased as the film is thinner.

Thus, the thickness of each negative electrode active material layer is preferably small. For example, when the total thickness of the negative electrode active material layers (the thickness of silicon in this case) needs to be 200 nm, the 200-nm thick negative electrode active material layers 201 is preferably obtained with more than one negative electrode active material layer 201. As illustrated in FIG. 2B, the separation layer 210 is preferably introduced between the plurality of negative electrode active material layers 201(a). Here, the total thickness is preferably 200 nm, excluding the thickness(es) of the separation layer(s) 210 from the thickness of the negative electrode active material layer 201(A).

The thickness of each negative electrode active material layer 201(a) is preferably small; however, if it is too small, the number of stacked layers increases, which might results in too many steps to form the negative electrode. For this reason, the thickness of each negative electrode active material layer 201(a) is preferably greater than or equal to 20 nm and less than 100 nm, and further preferably greater than or equal to 40 nm and less than or equal to 80 nm. Furthermore, n is preferably greater than or equal to 2 and less than or equal to 10, and further preferably greater than or equal to 2 and less than or equal to 5.

Even when the separation layer 210 is introduced between the negative electrode current collector layer 200 and the first negative electrode active material layer 201(a), the separation layer 210 does not contribute to a reduction in the thickness of the negative electrode active material layer 201(a) and might cause a reduction in capacity per volume. Accordingly, the negative electrode current collector layer 200 and the first negative electrode active material layer 201(a) are preferably in contact with each other.

The negative electrode active material layer 201(a) may have crystallinity or may be amorphous. An amorphous film is preferable in terms of high productivity. The crystallinity of the negative electrode active material layer 201(a) may differ between the time of charging and the time of discharging. For example, at the time when not containing lithium, such as the time right after being deposited and at the time when sufficiently releasing lithium, the negative electrode active material layer 201(a) may have crystallinity; in the process of accumulating lithium, the negative electrode active material layer 201(a) may be amorphous. When used in a secondary battery including an electrolyte solution, the negative electrode active material layer 201(a) may become amorphous by reacting with the electrolyte solution. The negative electrode active material layer 201(a) having crystallinity in the state without containing lithium is sometimes capable of accumulating a large amount of lithium. Note that in this specification and the like, having crystallinity refers to being a single crystal, polycrystalline, or microcrystalline.

### [Separation Layer 210]

If the separation layer 210 reacts with lithium ions, the capacity of the secondary battery is decreased. Therefore, the separation layer 210 is preferably composed of a material that hardly reacts with lithium ions. The separation layer thus preferably includes a Group 4 element. As Group 4 elements, Ti (titanium), Zr (zirconium), Hf (hafnium), and the like can be given. The separation layer 210 preferably includes titanium, titanium nitride (TiN), titanium oxide (TiOₓ, TiO, TiO₂, or the like), or titanium oxynitride (TiOxNy, 0<x<2, 0<y<1), in particular, and further preferably contains titanium or titanium nitride as its main component. In the case where the thickness of each of titanium, titanium nitride, titanium oxide, and titanium oxynitride is less than or equal to 100 nm, transfer of lithium is not inhibited and the battery capacity is not decreased. In other words, lithium ions are neither occluded nor released when the thickness of each of titanium, titanium nitride, titanium oxide, and titanium oxynitride is less than or equal to 100 nm. For this reason, titanium, titanium nitride, titanium oxide, and titanium oxynitride can each be favorably used for the separation layer 210 because the battery capacity is not decreased by such use for the separation layer. The other Group 4 elements are also expected to have an effect similar to that of titanium.

The separation layer 210 preferably has crystallinity. When the separation layer 210 has crystallinity, the conductivity of lithium ions can be increased. In addition, since a material that has a low reactivity with lithium ions is used for the separation layer, the crystallinity is less likely to vary before and after charging and the discharging.

The thickness of the separation layer 210 is preferably greater than or equal to 5 nm and less than or equal to 100 nm, further preferably greater than or equal to 5 nm and less than or equal to 40 nm, and still further preferably greater than or equal to 5 nm and less than or equal to 20 nm. The thickness of the separation layer 210 is preferably small because the too large thickness of the separation layer 210 lowers the charge and discharge capacity per weight of the electrode. On the other hand, the too small thickness of the separation layer 210 might cause a contact between a k-th (k is an integer greater than or equal to 1 and less than or equal to n−1) negative electrode active material layer 201(a) and a k+1-th negative electrode active material layer 201(a), for example. Hence, a thickness enough to function is necessary for the separation layer 210. Furthermore, to sufficiently function, the separation layer 210 is preferably in contact with the negative electrode active material layer 201(a).

The separation layer 210 may have a stacked-layer structure. For example, to fabricate the 20-nm thick separation layer 210, 10-nm thick titanium nitride may be stacked over 10-nm thick titanium as the separation layer 210.

Although the negative electrode active material layer 201(a) and the separation layer 210 are alternately stacked, another layer may exist between these layers. For example, an alloy layer including an element included in the negative electrode active material layer 201(a) and an element included in the separation layer 210 may exist.

Diffusion of the elements included in the layer, the film, and the like such as the negative electrode active material layer 201(a) and the separation layer 210 is not necessarily uniform in the film. For example, some of the elements may have a concentration gradient. For example, in the case where the above-described alloy layer exists, silicon or titanium in the alloy layer may have a concentration gradient.

The layer, the film, and the like such as the negative electrode active material layer 201(a) and the separation layer 210, which are adjacent to each other, can be confirmed to have compositions different therebetween by a TEM (transmission electron microscope) image, a STEM (scanning transmission electron microscope) image, a FFT (fast Fourier transform) analysis, EDX (energy dispersive X-ray spectrometry), an analysis in the depth direction by ToF-SIMS (time-of-flight secondary ion mass spectrometry), XPS (X-ray photoelectron spectroscopy), Auger electron spectroscopy, TDS (thermal desorption spectroscopy), or the like. The thickness of the layer, the film, and the like can be measured from the results of these.

For example, in the case where the alloy layer having a concentration gradient of silicon and titanium exists between the negative electrode active material layer 201 including silicon and the separation layer 210 including a titanium compound, the concentration gradient can be confirmed by an EDX analysis of a negative electrode cross section, an analysis in the depth direction from a negative electrode surface by ToF-SIMS, or the like. In this case, in the alloy layer, a region having a titanium concentration greater than or equal to ½ of the titanium concentration in the separation layer 210 may be treated as the separation layer 210. Similarly, in the alloy layer, a region having a titanium concentration less than ½ of the titanium concentration in the separation layer 210 may be treated as the negative electrode active material layer 201.

The negative electrode active material layer 201(a) and the separation layer 210 of one embodiment of the present invention do not necessarily have a film-like shape or a plate-like shape. The layers may partly include a curved surface or have a particle-like shape. For example, as illustrated in FIG. 2D, the shape may be a particle including the separation layer 210 between the plurality of negative electrode active material layers 201(a). In this case, for the radius and thickness of each of the negative electrode active material layer 201(a) and the separation layer 210, the thickness of each layer in this specification and the like can be referred to.

### Structure Example 2 of Negative Electrode

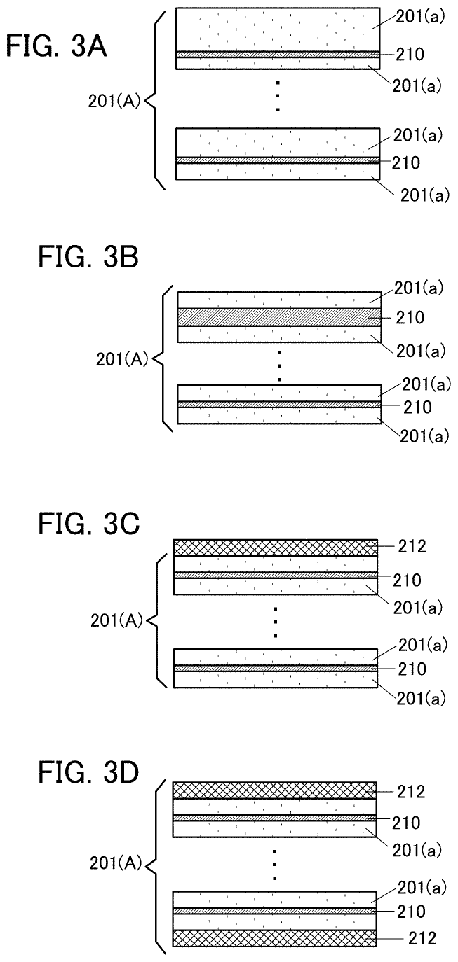

As illustrated in FIG. 3A, in the negative electrode active material layer 201(A) of one embodiment of the present invention, each negative electrode active material layer 201(a) may have a different thickness. The thickness of each negative electrode active material layer 201(a) is preferably greater than or equal to 20 nm and less than 100 nm, and further preferably greater than or equal to 40 nm and less than or equal to 80 nm, as described above. Moreover, the negative electrode active material layers 201(a) may differ in their material components. For example, the main component in the k-th negative electrode active material layer 201(a) may be Si while the main component in the k+1-th negative electrode active material layer 201(a) may be SiO.

### Structure Example 3 of Negative Electrode

In the negative electrode active material layer 201(A) of one embodiment of the present invention, each separation layer 210 may have a different thickness, as illustrated in FIG. 3B. The thickness of each of the separation layers 210 is preferably greater than or equal to 5 nm and less than or equal to 40 nm and further preferably greater than or equal to 5 nm and less than or equal to 20 nm, as described above. Moreover, the separation layers 210 may differ in their material components. For example, a k-th separation layer may include titanium while a k+1-th separation layer may include titanium nitride.

### Structure Example 4 of Negative Electrode

As illustrated in FIG. 3C, in the negative electrode active material layer 201(A) of one embodiment of the present invention, a layer 212 including titanium, titanium nitride, or titanium oxynitride is preferably further stacked over the uppermost layer of the negative electrode active material layer 201(a). For example, silicon is used for the uppermost layer of the negative electrode active material layer 201(a), which is in contact with an electrolyte layer or the electrolyte solution. The electrolyte layer or the electrolyte solution includes oxygen and fluorine in some cases. In this case, silicon in the uppermost layer of the negative electrode active material layer 201(a) might react with oxygen or fluorine owing to a cell reaction, which leads to a decrease in capacity. The reaction of silicon can be inhibited when the layer 212 including titanium, titanium nitride, or titanium oxynitride is stacked over the uppermost layer of the negative electrode active material layer 201(a); accordingly, the capacity decrease can be inhibited while the conductivity is maintained.

### Structure Example 5 of Negative Electrode

As illustrated in FIG. 3D, in the negative electrode active material layer 201(A) of one embodiment of the present invention, another layer 212 including titanium, titanium nitride, or titanium oxynitride may be stacked under the undermost layer of the negative electrode active material layer 201(a). With the layer 212 between the undermost layer of the negative electrode active material layer 201(a) and the negative electrode current collector layer 200, the possibility of occurrence of a crack, a breakage, or the like in the negative electrode active material layer 201(a) can be further reduced in some cases while the conductivity is maintained.

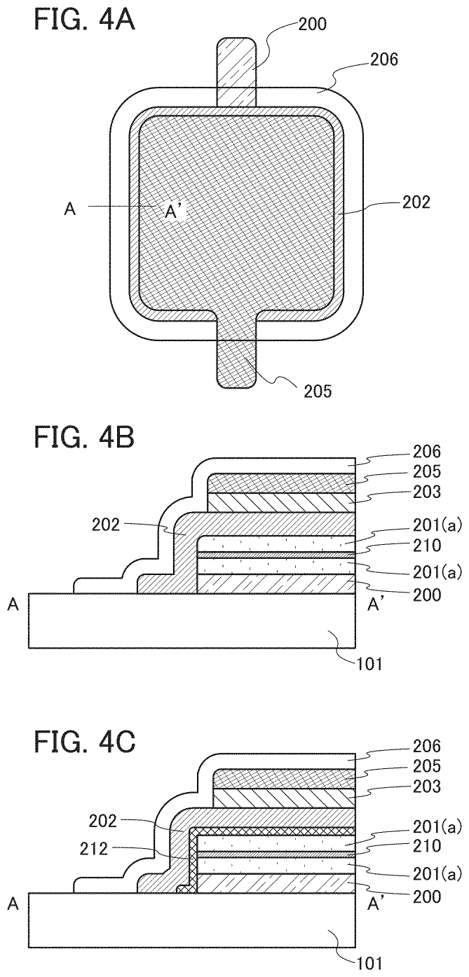

The solid electrolyte and the positive electrode are provided over the negative electrode with the above structure, whereby the secondary battery can be obtained. FIG. 4A is a top view of the secondary battery, and FIG. 4B is an example of a cross-sectional view taken along the line A-A′ in FIG. 4A. Note that in FIG. 4B, first and second negative electrode active material layers 201(A) are denoted by 201(1) and 201(2), respectively. The secondary battery includes, over the substrate 101, the negative electrode current collector layer 200, the negative electrode active material layer 201(A), the solid electrolyte layer 202, the positive electrode active material layer 203, the positive electrode current collector layer 205, and a protective layer 206.

FIG. 4B shows an example in which the secondary battery includes one separation layer 210 between the negative electrode active material layer 201(1) and the negative electrode active material layer 201(2), as in FIG. 2C.

FIG. 4C shows an example in which the secondary battery further includes the layer 212 including titanium, titanium nitride, or titanium oxynitride, as illustrated in FIG. 3C. The layer 212 including titanium, titanium nitride, or titanium oxynitride may be provided only in a region overlapping with the negative electrode active material layer 201(A), or may be provided so as to cover the negative electrode active material layer 201(A) and the negative electrode current collector layer 200 as in FIG. 4C. With the layer 212 including titanium, titanium nitride, or titanium oxynitride provided as in FIG. 4C, the possibility of occurrence of a crack, a breakage, or the like in the negative electrode active material layer 201(a) can be further reduced in some cases.

This embodiment can be implemented in appropriate combination with the other embodiments.

### Embodiment 2

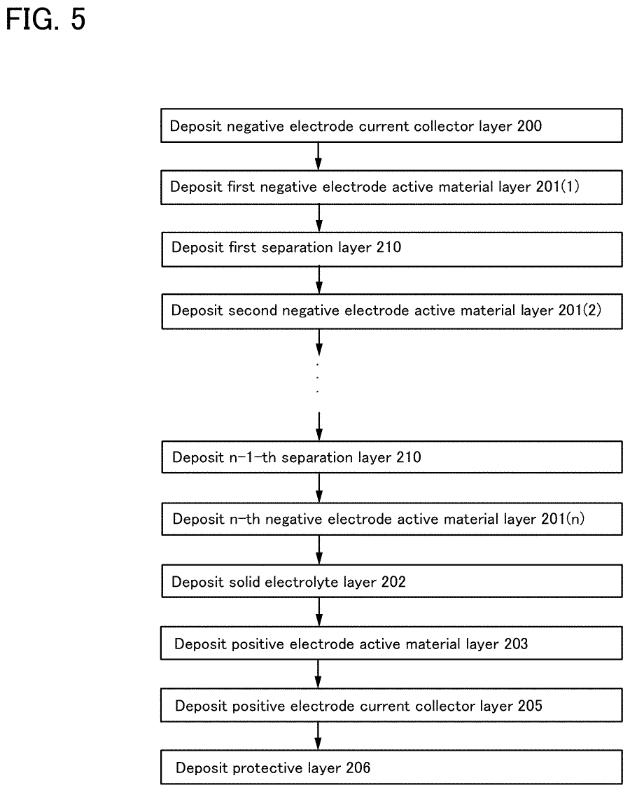

In this embodiment, a method for manufacturing the secondary battery described in Embodiment 1 will be described. FIG. 5 illustrates an example of a manufacturing flow for obtaining the structure illustrated in FIG. 4A and FIG. 4B.

First, the negative electrode current collector layer 200 is formed over the substrate. As a deposition method, a sputtering method, an evaporation method, or the like can be used. A substrate having conductivity may be used as a current collector. For the negative electrode current collector layer, the above-described material can be used. The thickness of the negative electrode current collector 200 is preferably greater than or equal to 5 nm and less than or equal to 100 nm, further preferably greater than or equal to 5 nm, and 30 nm.

Next, the first negative electrode active material layer 201(a) is deposited. This is designated as the first negative electrode active material layer 201(1) in the figure. The negative electrode active material layer 201(a) can be formed by a sputtering method or the like. For a material used, the description of the above embodiment can be referred to.

Next, the first separation layer 210 is deposited. As a deposition method of the separation layer 210, a sputtering method, an evaporation method, or the like can be used. In a sputtering method, with use of a metal mask, film deposition can be selectively performed. Alternatively, patterning may be performed on the separation layer 210 by selective removal due to dry etching or wet etching with use of a resist mask or the like. The separation layer 210 preferably includes titanium (Ti), titanium nitride (TiN), or titanium oxynitride (TiOxNy, 0<x<2, 0<y<1). In the case where titanium nitride is used for the separation layer 210, titanium nitride can be deposited by a reactive sputtering method using a titanium target and a nitrogen gas, for example. In the case where titanium oxynitride is used for the separation layer 210, titanium oxynitride can be deposited by a reactive sputtering method using a titanium oxide target and a nitrogen gas, for example.

Next, the second negative electrode active material layer 201(a) is deposited. This is designated as the first negative electrode active material layer 201(2) in the figure. Although the material and deposition method similar to those of the first negative electrode active material layer 201(a) can be used, a material and a deposition method different from those may be used to form the second negative electrode active material layer. The thickness of the second negative electrode active material layer 201(a) may also be similar to or different from that of the first negative electrode active material layer 201(a).

In the process after the second negative electrode active material layer 201(a), the separation layer 210 and the negative electrode active material layer 201(a) are alternately stacked according to the required number of negative electrode active material layers. Here, although there is no limitation on the thickness and material components of the negative electrode active material layers and the layers may differ in their thickness and material components, the layers preferably have similar material components and thickness so as to be easily formed by deposition. In addition, although there is no limitation on the thickness and material components of the separation layers 210 and the layers may differ in their thickness and material components, the layers preferably have similar material components and thickness so as to be easily formed by deposition. FIG. 4B shows the case where the negative electrode active material layer has two layers, the negative electrode active material layer 201(1) and the negative electrode active material layer 201(2), and the separation layer 210 is a single layer.

After an n-th negative electrode active material layer 201(n) is formed, the solid electrolyte layer 202 is deposited. Examples of materials for the solid electrolyte layer includes Li_{0.35}La_{0.55}TiO₃, La_{(2/3-x)}Li₍₃ₓ₎TiO₃, Li₃PO₄, LiₓPO_{(4-y)}Ny, LiNb₍₁₋ₓ₎Ta₍ₓ₎WO₆, Li₇La₃Zr₂O₁₂, Li₍₁₊ₓ₎Al₍ₓ₎Ti₍₂₋ₓ₎(PO₄)₃, Li₍₁₊ₓ₎Al₍ₓ₎Ge₍₂₋ₓ₎(PO₄)₃, and LiNbO₂. As a deposition method, a sputtering method, an evaporation method, or the like can be used. In addition, SiO_{X} (0<X≤2) can also be used for the solid electrolyte layer 202.

Next, the positive electrode active material layer 203 is formed. The positive electrode active material layer 203 can be formed by a sputtering method using a sputtering target including lithium cobalt oxide (e.g., LiCoO₂, LiCo₂O₄, or the like) as its main component, a sputtering target including a lithium manganese oxide (e.g., LiMnO₂, LiMn₂O₄, or the like) as its main component, or a lithium nickel oxide (e.g., LiNiO₂, LiNi₂O₄, or the like). A lithium manganese cobalt oxide (e.g., LiMnCoO₄, Li₂MnCoO₄, or the like), a ternary material of nickel-cobalt-manganese (e.g., LiNi_{1/3}Mn_{1/3}CO_{1/3}O₂: NCM), a ternary material of nickel-cobalt-aluminum (e.g., LiNi_{0.8}Co_{0.15}Al_{0.05}O₂: NCA), or the like can be used. Alternatively, the positive electrode active material layer 203 may be formed by a vacuum evaporation method.

The film deposition of the positive electrode active material layer 203 is preferably performed at high temperatures (higher than or equal to 500° C.). Alternatively, annealing treatment (at a temperature higher than or equal to 500° C.) is preferably performed after the positive electrode active material layer 203 is formed. With such a manufacturing method, the positive electrode active material layer 203 with further favorable crystallinity can be formed.

Next, the positive electrode current collector layer 205 is formed. As a material of the positive electrode current collector layer 205, the above-described material can be used.

Next, the protective layer 206 is formed. A silicon nitride film (also referred to as an SiN film) is preferably used as the protective layer 206. The silicon nitride film can be deposited by a sputtering method.

In the case where the negative electrode current collector layer 200 or the positive electrode current collector layer 205 is formed by a sputtering method, at least one of the positive electrode active material layer 203 and the negative electrode active material layer 201(a) is preferably formed by a sputtering method. A sputtering apparatus is capable of successive film deposition in one chamber or using a plurality of chambers and can also be a multi-chamber manufacturing apparatus or an in-line manufacturing apparatus. A sputtering method is a manufacturing method suitable for mass production that uses a chamber and a sputtering target. In addition, a sputtering method enables thin formation and thus excels in a film deposition property.

In the case where the negative electrode current collector layer 200 and the negative electrode active material layer 201(a) are deposited by a sputtering method, they are preferably deposited successively. In the case where the positive electrode current collector layer 205 and the positive electrode active material layer 203 are deposited by a sputtering method, they are preferably deposited successively. Successive deposition reduces contamination of an interface therebetween. Production time can also be shortened.

For film deposition of each layer described in this embodiment, a gas phase method (a vacuum evaporation method, a thermal spraying method, a pulsed laser deposition method (a PLD method), an ion plating method, a cold spray method, or an aerosol deposition method) can also be used without limitation to a sputtering method. Note that an aerosol deposition (AD) method is a method in which deposition is performed without heating a substrate. The aerosol means microparticles dispersed in a gas. Alternatively, a CVD method or an ALD (Atomic Layer Deposition) method may be used.

This embodiment can be implemented in appropriate combination with the other embodiments.

### Embodiment 3

In this embodiment, examples of materials which can be used for a secondary battery including the negative electrode of one embodiment of the present invention are described. In this embodiment, a secondary battery in which a positive electrode, the negative electrode of one embodiment of the present invention, and an electrolyte solution are wrapped in an exterior body will be described as an example.

### [Positive Electrode]

The positive electrode includes a positive electrode active material layer and a positive electrode current collector layer.

### <Positive Electrode Active Material Layer>

The positive electrode active material layer can include a positive electrode active material film or a positive electrode active material particle as the positive electrode active material. When the positive electrode active material film is included, it can be combined with the negative electrode of one embodiment of the present invention to form a thin film battery, which is preferable. When the positive electrode active material particle is included, a high-capacity positive electrode can be fabricated at low cost, which increases productivity. When the positive electrode active material particle is included, a so-called core-shell structure, where the surface portion and the inner portion differ in their compositions is preferred because cycle performance might be improved.

The positive electrode active material layer may contain a conductive additive and a binder.

Examples of the material of the positive electrode active material particle include a composite oxide with an olivine crystal structure, a composite oxide with a layered rock-salt crystal structure, and a composite oxide with a spinel crystal structure. For example, a compound such as LiFePO₄, LiFeO₂, LiCoO₂, LiNiO₂, LiMn₂O₄, V₂O₅, Cr₂O₅, or MnO₂ can be given.

In particular, LiCoO₂ is preferable because it has high capacity and higher stability in the air and higher thermal stability than LiNiO₂.

It is preferable to add lithium nickel oxide (LiNiO₂ or LiNi₁₋ₓMₓO₂ (0<x<1) (M=Co, Al, or the like)) to a lithium-containing material with a spinel crystal structure which contains manganese such as LiMn₂O₄. This composition can improve the characteristics of the secondary battery.

Another example of the positive electrode active material is a lithium-manganese composite oxide represented by a composition formula LiₐMn_{b}M_{c}O_{d}. Here, the element M is preferably a metal element other than lithium and manganese, or silicon or phosphorus, further preferably nickel. Furthermore, in the case where the whole film of a lithium-manganese composite oxide is measured, it is preferable to satisfy the following at the time of discharging: 0<a/(b+c)<2; c>0; and 0.26≤(b+c)/d<0.5. Note that the composition of metal, silicon, phosphorus, and other elements in the whole film of a lithium-manganese composite oxide can be measured with, for example, an ICP-MS (inductively coupled plasma mass spectrometer). The composition of oxygen in the whole particle of a lithium-manganese composite oxide can be measured by, for example, EDX (energy dispersive X-ray spectroscopy). Alternatively, the composition can be measured by ICP-MS combined with fusion gas analysis and valence evaluation of XAFS (X-ray absorption fine structure) analysis. Note that the lithium-manganese composite oxide is an oxide containing at least lithium and manganese, and may contain at least one element selected from chromium, cobalt, aluminum, nickel, iron, magnesium, molybdenum, zinc, indium, gallium, copper, titanium, niobium, silicon, phosphorus, and the like.

Examples of the conductive additive include a carbon material, a metal material, and a conductive ceramic material. Alternatively, a fiber material may be used as the conductive additive. The content of the conductive additive to the total amount of the active material layer is preferably greater than or equal to 1 wt % and less than or equal to 10 wt %, and further preferably greater than or equal to 1 wt % and less than or equal to 5 wt %.

A network for electric conduction can be formed in the positive electrode active material by the conductive additive. The conductive additive also allows the maintenance of a path for electric conduction between the positive electrode active materials. The addition of the conductive additive to the active material layer increases the electric conductivity of the active material layer.

Examples of the conductive additive include natural graphite, artificial graphite such as mesocarbon microbeads, and carbon fiber. As carbon fiber, mesophase pitch-based carbon fiber and isotropic pitch-based carbon fiber can be used. Other examples of carbon fiber include carbon nanofiber and carbon nanotube. Carbon nanotube can be formed by, for example, a vapor deposition method. Other examples of the conductive additive include carbon materials such as carbon black (e.g., acetylene black (AB)), graphite (black lead) particles, graphene, and fullerene. Alternatively, metal powder or metal fibers of copper, nickel, aluminum, silver, gold, or the like, a conductive ceramic material, or the like can be used. These materials may be used in combination.

Alternatively, a graphene compound may be used as the conductive additive

A graphene compound has excellent electrical characteristics of high conductivity and excellent physical properties of high flexibility and high mechanical strength in some cases. A graphene compound has a sheet-like shape. A graphene compound sometimes has a curved surface and enables low-resistance surface contact. Furthermore, a graphene compound has extremely high conductivity even with a small thickness in some cases and thus allows a conductive path to be formed in an active material layer efficiently even with a small amount. Hence, a graphene compound is preferably used as the conductive additive, in which case the area where the active material and the conductive additive are in contact with each other can be increased.

As the binder, a rubber material such as styrene-butadiene rubber (SBR), styrene-isoprene-styrene rubber, acrylonitrile-butadiene rubber, butadiene rubber, or ethylene-propylene-diene copolymer can be used, for example. Alternatively, fluororubber can be used as the binder.

For the binder, for example, water-soluble polymers are preferably used. As the water-soluble polymers, for example, a polysaccharide can be used. As the polysaccharide, for example, a cellulose derivative such as carboxymethyl cellulose (CMC), methyl cellulose, ethyl cellulose, hydroxypropyl cellulose, diacetyl cellulose, and regenerated cellulose or starch can be used. It is further preferred that such water-soluble polymers be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

A plurality of the above materials may be used in combination for the binder.

For example, a material having a significant viscosity modifying effect and another material may be used in combination. For example, a rubber material or the like has high adhesion or high elasticity but may have difficulty in viscosity modification when mixed in a solvent. In such a case, a rubber material or the like is preferably mixed with a material having a significant viscosity modifying effect, for example. As a material having a significant viscosity modifying effect, for example, a water-soluble polymer is preferably used. An example of a water-soluble polymer having an especially significant viscosity modifying effect is the above-mentioned polysaccharide; for example, a cellulose derivative such as carboxymethyl cellulose (CMC), methyl cellulose, ethyl cellulose, hydroxypropyl cellulose, diacetyl cellulose, or regenerated cellulose, or starch can be used.

Note that a cellulose derivative such as carboxymethyl cellulose obtains a higher solubility when converted into a salt such as a sodium salt or an ammonium salt of carboxymethyl cellulose, and accordingly, easily exerts an effect as a viscosity modifier. The high solubility can also increase the dispersibility of an active material and other components in the formation of slurry for an electrode. In this specification, cellulose and a cellulose derivative used as a binder of an electrode include salts thereof.

The water-soluble polymers stabilize viscosity by being dissolved in water and allow stable dispersion of the active material and another material combined as a binder, such as styrene-butadiene rubber, in an aqueous solution. Furthermore, a water-soluble polymer is expected to be easily and stably adsorbed on the active material surface because it has a functional group. Many cellulose derivatives, such as carboxymethyl cellulose, have functional groups such as a hydroxyl group and a carboxyl group. Because of functional groups, polymers are expected to interact with each other and cover the active material surface in a large area.

In the case where the binder covering or being in contact with the active material surface forms a film, the film is expected to serve as a passivation film to suppress the decomposition of the electrolyte solution. Here, the passivation film refers to a film without electronic conductivity or a film with extremely low electric conductivity, and can suppress the decomposition of an electrolyte solution at a potential at which a battery reaction occurs in the case where the passivation film is formed on the active material surface, for example. It is preferred that the passivation film can conduct lithium ions while suppressing electric conduction.

### [Electrolyte Solution]

The electrolyte solution contains a solvent and an electrolyte. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

Alternatively, the use of one or more ionic liquids (room temperature molten salts) that are less likely to burn and volatize as the solvent of the electrolyte solution can prevent a power storage device from exploding or catching fire even when the power storage device internally shorts out or the internal temperature increases owing to overcharge or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As an electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), and LiN(C₂F₅SO₂)₂ can be used, or two or more of these lithium salts can be used in an appropriate combination in an appropriate ratio.

The electrolyte solution used for a power storage device is preferably highly purified and contains small numbers of dust particles and elements other than the constituent elements of the electrolyte solution (hereinafter also simply referred to as “impurities”). Specifically, the weight ratio of impurities to the electrolyte solution is preferably less than or equal to 1%, further preferably less than or equal to 0.1%, still further preferably less than or equal to 0.01%.

An additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of the additive agent in the whole solvent is, for example, higher than or equal to 0.1 wt % and lower than or equal to 5 wt %.

Alternatively, a polymer gelled electrolyte obtained in such a manner that a polymer is swelled with an electrolyte solution may be used.

When a polymer gel electrolyte is used, safety against liquid leakage and the like is improved. Furthermore, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used. Examples include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

For the negative electrode of one embodiment of the present invention described in Embodiment 1, the negative electrode active material layer 201(a) and the separation layer 210 can be alternately deposited over the negative electrode current collector layer 200 by a coating method. For example, electrode slurry including Si and slurry including Ti are alternately applied, so that the negative electrode of one embodiment of the present invention can be fabricated. A coating method is effective for an increase in area and a reduction in cost.

This embodiment can be implemented in appropriate combination with the other embodiments.

### Embodiment 4

Solid-state secondary batteries can be connected in series in order to increase the output voltage of the solid-state secondary batteries. An example of solid-state secondary batteries connected in series will be described in this embodiment.

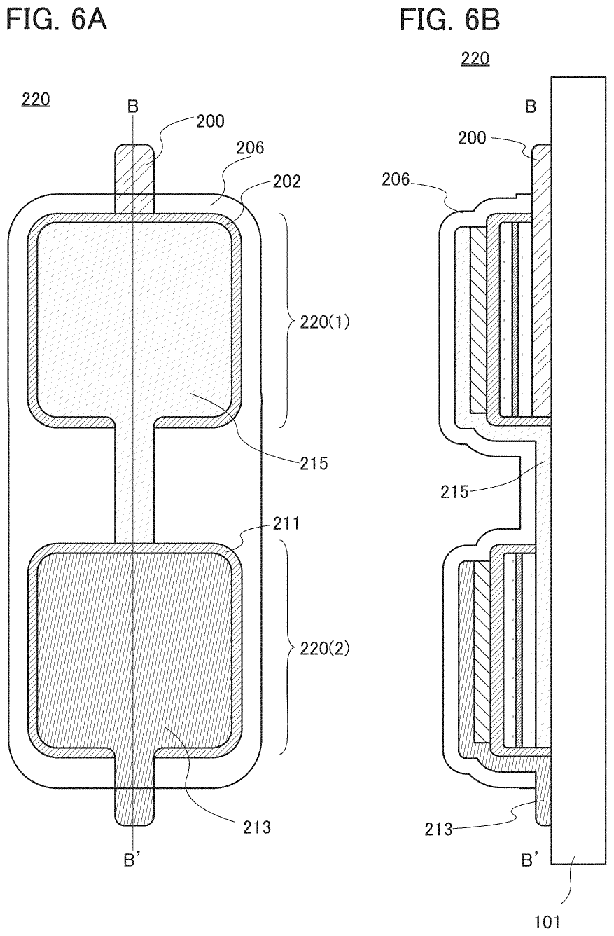

FIG. 6A illustrates a top view of a secondary battery in which a first secondary battery 220(1) and a second secondary battery 220(2) are connected in series. FIG. 6B is a cross-sectional view along B-B′ in FIG. 6A. In FIG. 6A and FIG. 6B, the same portions as the portions in FIG. 4A and FIG. 4B described in Embodiment 2 are denoted by the same reference numerals.

The first secondary battery 220(1) illustrated in FIG. 6A includes, over the substrate 101, the negative electrode current collector layer 200, a first negative electrode, a first solid electrolyte layer 202, a first positive electrode, and a current collector layer 215. The second secondary battery 220(2) includes, over the substrate 101, the current collector layer 215, a second negative electrode, a second solid electrolyte layer 211, a second positive electrode, and a current collector layer 213.

The current collector layer 215 functions as a positive electrode current collector layer of the first secondary battery 220(1) and also as a negative electrode current collector layer of the second secondary battery 220(2). The current collector layer 215 electrically connects the first secondary battery 220(1) and the second secondary battery 220(2). The first negative electrode and the second negative electrode are each the negative electrode described in the above embodiment.

This embodiment can be implemented in appropriate combination with the other embodiments.

### Embodiment 5

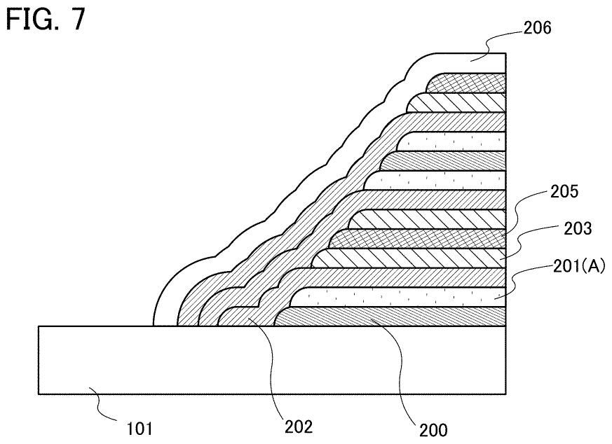

An example of a multi-layer cell will be described in this embodiment. FIG. 7 illustrates one of embodiments describing the case of a multi-layer cell of a thin-film-type solid-state secondary battery.

FIG. 7 illustrates an example of a cross section of a three-layer cell.

A first cell is formed in such a manner that the negative electrode current collector layer 200 is formed over the substrate 101, and the negative electrode active material layer 201(A), the solid electrolyte layer 202, the positive electrode active material layer 203, and the positive electrode current collector layer 205 are sequentially formed over the negative electrode current collector layer 200.

Furthermore, a second cell is formed in such a manner that a positive negative electrode active material layer, a second solid electrolyte layer, a second negative electrode active material layer, and a second negative electrode current collector layer are sequentially formed over the positive electrode current collector layer 205.

Moreover, a third cell is formed in such a manner that a third negative electrode active material layer, a third solid electrolyte layer, a third positive electrode active material layer, and a third positive electrode current collector layer are sequentially formed over the second negative electrode current collector layer.

Lastly, the protective layer 206 is formed in FIG. 7. The three-layer stack illustrated in FIG. 7 has a structure of series connection in order to increase the capacity but can be connected in parallel with an external wiring. Series connection, parallel connection, or series-parallel connection can also be selected with an external wiring.

Note that the first solid electrolyte layer 202, the second solid electrolyte layer, and the third solid electrolyte layer are preferably formed using the same material, leading to a reduction in the manufacturing cost.

This embodiment can be implemented in appropriate combination with the other embodiments.

### Embodiment 6

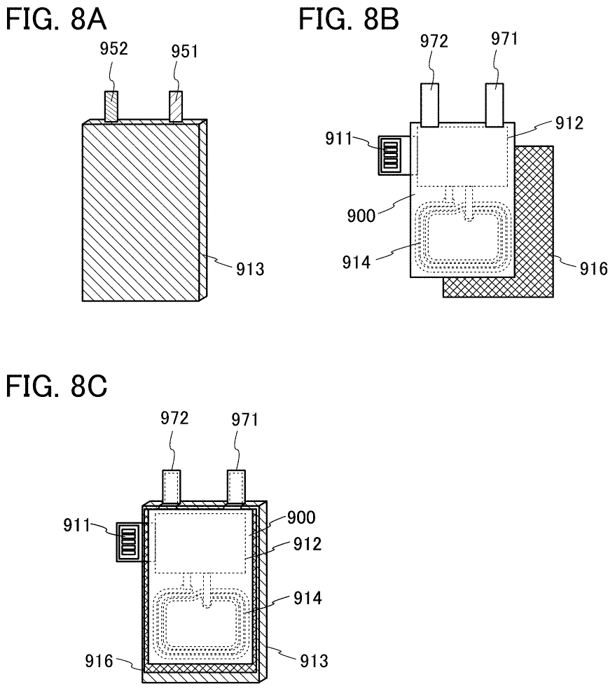

FIG. 8A is an external view of a thin-film-type solid-state secondary battery including the negative electrode of one embodiment of the present invention. The secondary battery 913 includes a terminal 951 and a terminal 952. The terminal 951 and the terminal 952 are electrically connected to a positive electrode and a negative electrode, respectively.

FIG. 8B is an external view of a battery control circuit. The battery control circuit shown in FIG. 8B includes a substrate 900 and a layer 916. A circuit 912 and an antenna 914 are provided over the substrate 900. The antenna 914 is electrically connected to the circuit 912. The terminal 971 and the terminal 972 are electrically connected to the circuit 912. The circuit 912 is electrically connected to the terminal 911.

The terminal 911 is connected to a device to which electric power of the thin-film-type solid-state secondary battery is supplied, for example. For example, the terminal 911 is connected to a display device, a sensor, or the like.

The layer 916 has a function of blocking an electromagnetic field from the secondary battery 913, for example. As the layer 916, for example, a magnetic body can be used.

FIG. 8C shows an example in which the battery control circuit shown in FIG. 8B is provided over the secondary battery 913. The terminal 971 and the terminal 972 are electrically connected to the terminal 951 and the terminal 952, respectively. The layer 916 is provided between the substrate 900 and the secondary battery 913.

A substrate having flexibility is preferably used as the substrate 900.

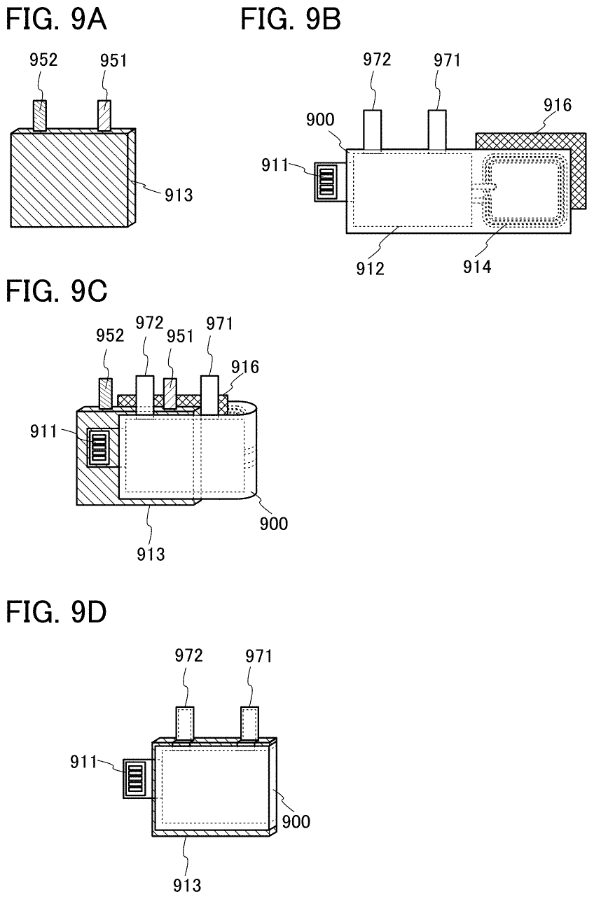

By using a substrate having flexibility as the substrate 900, a thin battery control circuit can be achieved. As shown in FIG. 9D described later, the battery control circuit can be wound around the secondary battery.

FIG. 9A is an external view of a thin-film-type solid-state secondary battery. A battery control circuit shown in FIG. 9B includes the substrate 900 and the layer 916.

As shown in FIG. 9C, the substrate 900 is bent to fit the shape of the secondary battery 913, and the battery control circuit is provided around the secondary battery, whereby the battery control circuit can be wound around the secondary battery as shown in FIG. 9D.

This embodiment can be implemented in appropriate combination with the other embodiments.

### Embodiment 7

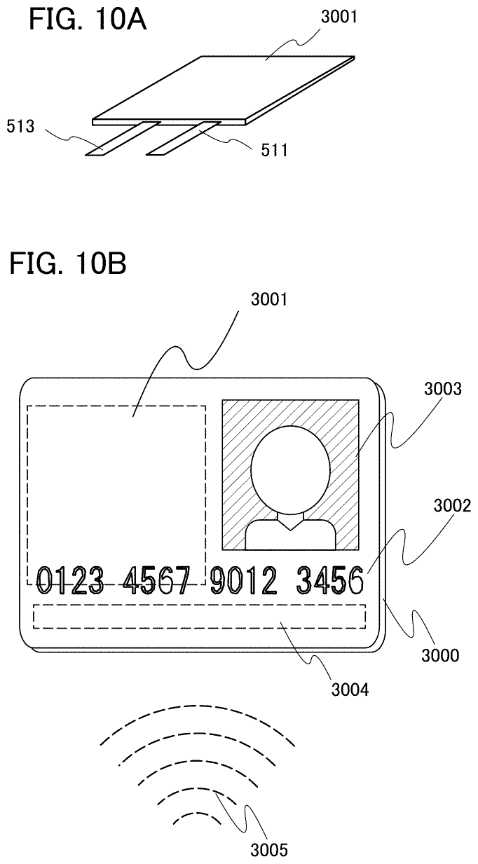

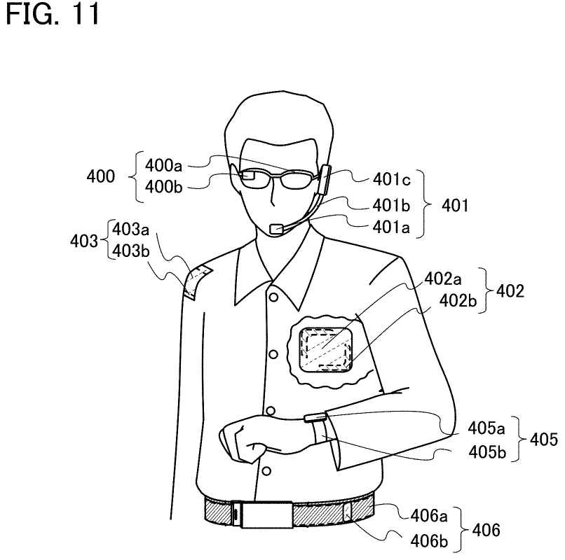

In this embodiment, examples of electronic devices using thin-film-type secondary batteries are described with reference to FIG. 10A, FIG. 10B, and FIG. 11. Since a crack, a breakage, or the like in the secondary battery including the negative electrode of one embodiment of the present invention can be inhibited, the cycle performance, reliability, and safety of the secondary battery can be improved. Such a secondary battery can be favorably used for electronic devices given below. The secondary battery can be favorably used particularly for an electronic device that is required to have durability.

FIG. 10A is an external perspective view of a thin-film-type secondary battery 3001. The thin-film-type secondary battery 3001 is subjected to sealing with an exterior body such as a laminate film or an insulating film such that a positive electrode lead electrode 513 electrically connected to a positive electrode of a solid-state secondary battery and a negative electrode lead electrode 511 electrically connected to a negative electrode project.

FIG. 10B illustrates an IC card which is an example of an application device using a thin-film-type secondary battery of the present invention. The thin-film-type secondary battery 3001 can be charged with electric power obtained by power feeding from a radio wave 3005. In an IC card, an antenna, an IC 3004, and the thin-film-type secondary battery 3001 are provided. An ID 3002 and a photograph 3003 of a worker who wears the management badge are attached on the IC card 3000. A signal such as an authentication signal can be transmitted from the antenna using the electric power charged in the thin-film-type secondary battery 3001.

An active matrix display device may be provided instead of the photograph 3003. As examples of the active matrix display device, a reflective liquid crystal display device, an organic EL display device, electronic paper, or the like can be given. An image (a moving image or a still image) or time can be displayed on the active matrix display device. Electric power for the active matrix display device can be supplied from the thin-film-type secondary battery 3001.

A plastic substrate is used for the IC card, and thus an organic EL display device using a flexible substrate is preferable.

A solar cell may be provided instead of the photograph 3003. By irradiation with external light, light can be absorbed to generate electric power, and the thin-film-type secondary battery 3001 can be charged with the electric power.

Without limitation to the IC card, the thin-film-type secondary battery can be used for a power source of an in-vehicle wireless sensor, a secondary battery for a MEMS device, or the like.

FIG. 11 illustrates examples of wearable devices. A secondary battery is used as a power source of a wearable device in many cases. To have improved splash resistance, water resistance, or dust resistance in daily use or outdoor use by a user, a wearable device is desirably capable of being charged wirelessly as well as being charged with a wire whose connector portion for connection is exposed.

For example, the secondary battery of one embodiment of the present invention can be incorporated in a glasses-type device 400 as illustrated in FIG. 11. The glasses-type device 400 includes a frame 400a and a display portion 400b. A secondary battery is incorporated in a temple of the frame 400a having a curved shape, whereby the glasses-type device 400 can be lightweight, have a well-balanced weight, and be used continuously for a long time. When the secondary battery described in the above embodiment is included, a structure that can support space saving due to a reduction in the size of a housing can be achieved.

Furthermore, the secondary battery of one embodiment of the present invention can be incorporated in a headset-type device 401. The headset-type device 401 includes at least a microphone portion 401a, a flexible pipe 401b, and an earphone portion 401c. The secondary battery can be provided in the flexible pipe 401b or the earphone portion 401c. When the secondary battery described in the above embodiment is included, a structure that can support space saving due to a reduction in the size of a housing can be achieved.

The secondary battery can also be incorporated in a device 402 that can be directly attached to a human body. A secondary battery 402b can be provided in a thin housing 402a of the device 402. When the secondary battery described in the above embodiment is included, a structure that can support space saving due to a reduction in the size of a housing can be achieved.

The secondary battery can also be incorporated in a device 403 that can be attached to clothing. A secondary battery 403b can be provided in a thin housing 403a of the device 403. When the secondary battery described in the above embodiment is included, a structure that can support space saving due to a reduction in the size of a housing can be achieved.

Furthermore, the secondary battery of one embodiment of the present invention can be incorporated in a belt-type device 406. The belt-type device 406 includes a belt portion 406a and a wireless power feeding and receiving portion 406b, and the secondary battery of one embodiment of the present invention can be incorporated in the belt portion 406a. When the secondary battery described in the above embodiment is included, a structure that can support space saving due to a reduction in the size of a housing can be achieved.

The secondary battery can also be incorporated in a watch-type device 405. The watch-type device 405 includes a display portion 405a and a belt portion 405b, and the secondary battery can be provided in the display portion 405a or the belt portion 405b. The solid-state secondary battery described in the above embodiment may be included, and thus a structure that can support space saving due to a reduction in the size of a housing can be achieved.

The display portion 405a can display various kinds of information such as reception information of an e-mail or an incoming call in addition to time.

Since the watch-type device 405 is a type of wearable device that is directly wrapped around an arm, a sensor that measures pulse, blood pressure, or the like of a user can be incorporated therein. Data on the exercise quantity and health of the user can be stored and used for health maintenance.

This embodiment can be implemented in appropriate combination with the other embodiments.

### Embodiment 8

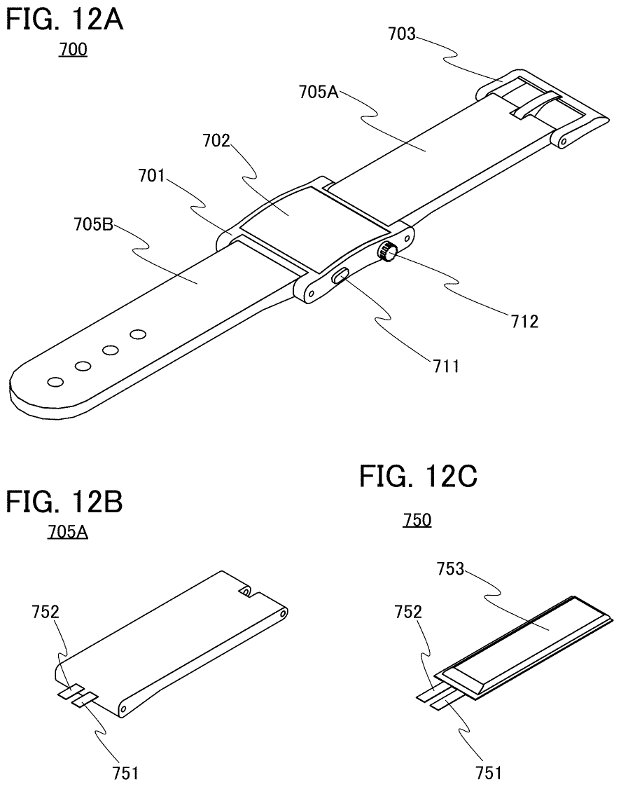

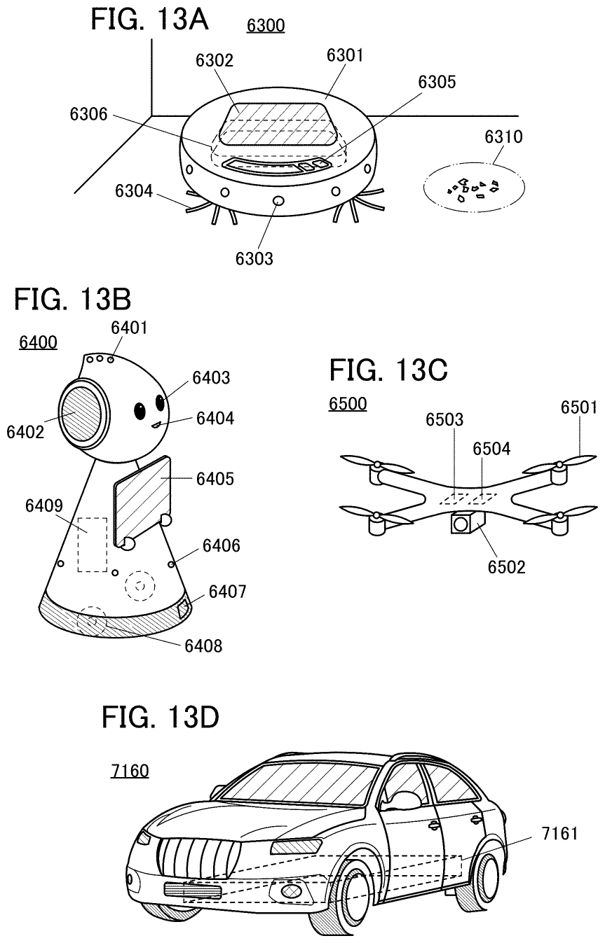

In this embodiment, electronic devices each using the secondary battery including the negative electrode of one embodiment of the present invention are described with reference to FIG. 12A to FIG. 12C and FIG. 13A to FIG. 13D. Since a crack, a breakage, or the like in the secondary battery including the negative electrode of one embodiment of the present invention can be inhibited, the cycle performance, reliability, and safety of the secondary battery can be improved. Such a secondary battery can be favorably used for electronic devices given below. The secondary battery can be favorably used particularly for an electronic device that is required to have durability.

FIG. 12A is a perspective view of a watch-type portable information terminal (also called a smartwatch) 700. The portable information terminal 700 includes a housing 701, a display panel 702, a clasp 703, bands 705A and 705B, and operation buttons 711 and 712.

The display panel 702 mounted in the housing 701 doubling as a bezel includes a rectangular display region. The display region has a curved surface. The display panel 702 preferably has flexibility. Note that the display region may be non-rectangular.

The bands 705A and 705B are connected to the housing 701. The clasp 703 is connected to the band 705A. The band 705A and the housing 701 are connected such that a connection portion rotates via a pin. In a similar manner, the band 705B and the housing 701 are connected to each other and the band 705A and the clasp 703 are connected to each other.

FIG. 12B and FIG. 12C are perspective views of the band 705A and a secondary battery 750, respectively. The band 705A includes the secondary battery 750. As the secondary battery 750, the secondary battery described in the above embodiment can be used. The secondary battery 750 is embedded in the band 705A, and the positive electrode lead 751 and the negative electrode lead 752 partly protrude from the band 705A (see FIG. 12B). The positive electrode lead 751 and the negative electrode lead 752 are electrically connected to the display panel 702. The surface of the secondary battery 750 is covered with an exterior body 753 (see FIG. 12C). Note that the pin may function as an electrode. Specifically, through the pin that connects the band 705A and the housing 701, the positive electrode lead 751 and the display panel 702 may be electrically connected to each other and the negative electrode lead 752 and the display panel 702 may be electrically connected to each other. This simplifies the structure of the connection portion between the band 705A and the housing 701.

The secondary battery 750 has flexibility. Thus, the band 705A can be formed so as to incorporate the secondary battery 750. For example, the secondary battery 750 is set in a mold that the outside shape of the band 705A fits and a material of the band 705A is poured in the mold and cured, so that the band 705A illustrated in FIG. 12B can be formed.

In the case where a rubber material is used as the material for the band 705A, rubber is cured through heat treatment. For example, in the case where fluorine rubber is used as a rubber material, it is cured through heat treatment at 170° C. for 10 minutes. In the case where silicone rubber is used as a rubber material, it is cured through heat treatment at 150° C. for 10 minutes.

Examples of the material for the band 705A include fluorine rubber, silicone rubber, fluorosilicone rubber, and urethane rubber.

Note that the portable information terminal 700 in FIG. 12A can have a variety of functions such as a function of displaying a variety of data (e.g., a still image, a moving image, and a text image) on the display region, a touch panel function, a function of displaying a calendar, date, time, and the like, a function of controlling processing with a variety of software (programs), a wireless communication function, a function of being connected to a variety of computer networks with a wireless communication function, a function of transmitting and receiving a variety of data with a wireless communication function, and a function of reading out a program or data stored in a recording medium and displaying it on the display region.

The housing 701 can include a speaker, a sensor (a sensor having a function of measuring force, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays), a microphone, and the like. Note that the portable information terminal 700 can be manufactured using a light-emitting element for the display panel 702.

Although FIG. 12A illustrates the example where the secondary battery 750 is incorporated in the band 705A, the secondary battery 750 may be incorporated in the band 705B. The band 705B can be formed using a material similar to that for the band 705A.

FIG. 13A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a variety of sensors 6306, and the like. Although a tire, an inlet, and the like are not illustrated, the cleaning robot 6300 is provided with the tire, the inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images shot by the cameras 6303. In the case where the cleaning robot 6300 detects an object that is likely to be caught in the brush 6304 (e.g., a wire) by image analysis, the rotation of the brush 6304 can be stopped. The cleaning robot 6300 further includes a secondary battery of one embodiment of the present invention and the semiconductor device or the electronic component. The cleaning robot 6300 including the secondary battery of one embodiment of the present invention can be a highly reliable electronic device that can operate for a long time.

FIG. 13B illustrates an example of a robot. A robot 6400 illustrated in FIG. 13B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of shooting an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes the secondary battery of one embodiment of the present invention and the semiconductor device or the electronic component. The robot 6400 including the secondary battery of one embodiment of the present invention can be a highly reliable electronic device that can operate for a long time.

FIG. 13C illustrates an example of a flying object. A flying object 6500 illustrated in FIG. 13C includes propellers 6501, a camera 6502, a secondary battery 6503, and the like and has a function of flying autonomously.

For example, image data taken by the camera 6502 is stored in an electronic component 6504. The electronic component 6504 can analyze the image data to detect whether there is an obstacle in the way of the movement. Moreover, the electronic component 6504 can estimate the remaining battery level from a change in the power storage capacity of the secondary battery 6503. The flying object 6500 further includes the secondary battery 6503 of one embodiment of the present invention. The flying object 6500 including the secondary battery of one embodiment of the present invention can be a highly reliable electronic device that can operate for a long time.

FIG. 13D illustrates an example of an automobile. An automobile 7160 includes a secondary battery 7161, an engine, tires, a brake, a steering gear, a camera, and the like. The automobile 7160 further includes the secondary battery 7161 of one embodiment of the present invention. The automobile 7160 using the secondary battery of one embodiment of the present invention can be a high-mileage and long-life automobile with a high level of safety and high reliability.

This embodiment can be implemented in appropriate combination with the other embodiments.

### Embodiment 9

A device described in this embodiment includes at least a biosensor and the secondary battery described in the above embodiment which supplies power to the biosensor, and can obtain various kinds of biological data using infrared light and visible light and make the memory store the data. Such biological data can be used for both user's personal authentication uses and health care uses. The secondary battery of one embodiment of the present invention has higher discharge capacity, high cycle performance, and a high level of safety. Thus, the device can be used for a long time.

The biosensor is a sensor for obtaining biological data and obtains biological data that can be used for health care uses. Examples of biological data include pulse waves, blood glucose levels, oxygen saturation levels, and neutral fat concentrations. The data is stored in the memory.

Furthermore, the device described in this embodiment is preferably provided with a unit for obtaining other biological data. Examples of such biological data include internal biological data such as an electrocardiogram, a blood pressure, and a body temperature and superficial biological data such as facial expression, a complexion, and a pupil. In addition, data on the number of steps taken, exercise intensity, a height difference in a movement, and a meal (e.g., calorie intake and nutrients) are important for health care. The use of a plurality of kinds of biological data and the like enables complex management of physical conditions, leading to not only daily health management but also early detection of injuries and diseases.

Blood pressure can be calculated from an electrocardiogram and a difference in timing of two pulsations of a pulse wave (a period of pulse wave propagation time), for example. A high blood pressure results in a short pulse wave propagation time, whereas a low blood pressure results in a long pulse wave propagation time. The body conditions of the user can be estimated from a relationship between the heart rate and the blood pressure that are calculated from the electrocardiogram and the pulse wave. For example, when both the heart rate and the blood pressure are high, it can be estimated that the user is nervous or excited, whereas when both the heart rate and the blood pressure are low, it can be estimated that the user is relaxed. When the state where the blood pressure is low and the heart rate is high is continued, the user might suffer from a heart disease or the like.

The user can check the biological data measured with the electronic device, one's own body conditions estimated on the basis of the data, and the like at any time; thus, health awareness is improved. This may inspire the user to reconsider the daily habits, for example, to avoid over-eating and over-drinking, get enough exercise, manage one's physical conditions, and have a medical examination at a medical institution as necessary.

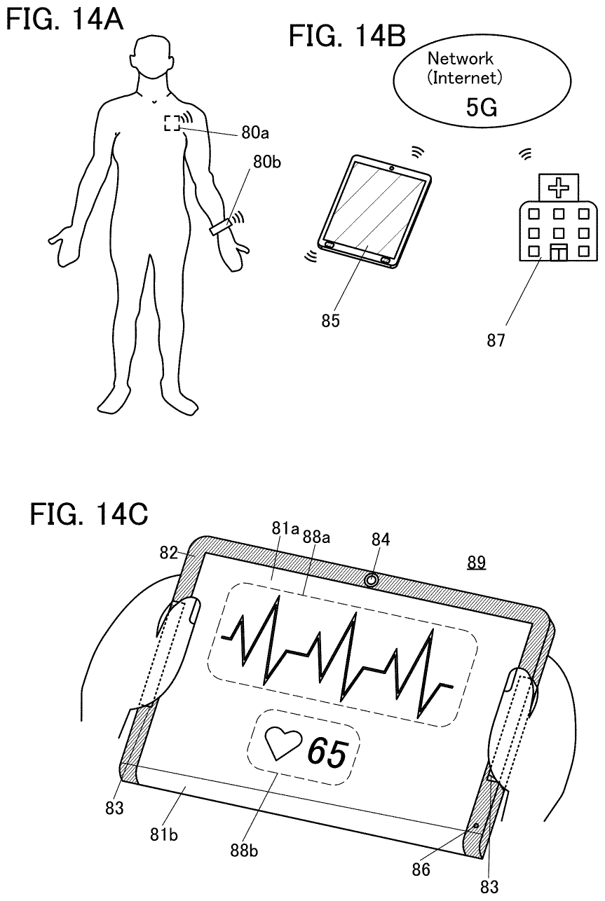

Data may be shared among a plurality of biosensors. FIG. 14A illustrates an example in which a biosensor 80a is embedded in a user's body and an example in which a biosensor 80b is worn on the user's wrist. Devices illustrated in FIG. 14A are, for example, a device including the biosensor 80a capable of electrocardiogram monitoring and a device including the biosensor 80b capable of heart rate monitoring by optically measurement of the pulse on the user's arm. Note that the wearable device such as a watch or a wristband illustrated in FIG. 14A is not limited to a heart rate meter, and a variety types of biosensors can be used.

As the predetermined conditions of the embedded device illustrated in FIG. 14A, the device is small, hardly generates heat, and causes no allergic reaction or the like even when the device is in contact with the user's skin. The secondary battery used in the device of one embodiment of the present invention is preferable because it is small, hardly generates heat, and causes no allergic reaction or the like. The embedded device preferably incorporates an antenna so as to enable wireless charging.

The device embedded into the living body, which is illustrated in FIG. 14A, is not limited to the biosensor capable of electrocardiogram monitoring, and a biosensor capable of obtaining other biological data can be used.

The biosensor 80b incorporated in the device may temporarily store data in a memory incorporated in the device. Alternatively, the data obtained by the biosensor may be transmitted to a portable data terminal 85 in FIG. 14B with or without a wire, and waveforms may be detected in the portable data terminal 85. The portable data terminal 85 corresponds to a smartphone or the like and can detect whether or not a problem such as an irregular heartbeat occurs from the data obtained from the biosensors. In the case where the data obtained by the plurality of biosensors are transmitted to the portable data terminal 85 with a wire, it is preferable that data obtained by connection with a wire be collectively transmitted. Note that date may be automatically given to the detected data, and the data may be stored in a memory of the portable data terminal 85 and managed personally. Alternatively, the data may be transmitted to a medical institution 87 such as a hospital via a network (including the Internet) as illustrated in FIG. 14B. The data can be managed in a data server of the hospital and used as inspection data in treatment. Since medical data sometimes swells to a huge amount of data, an network including Bluetooth (registered trademark) and a frequency band from 2.4 GHz to 2.4835 GHz may be used for the high-speed data communication between the biosensor 80b and the portable data terminal 85, and the fifth-generation (5G) wireless system may be used for the high-speed data communication between the portable data terminals 85. For the fifth-generation (5G) wireless system, frequency bands of the 3.7 GHz band, the 4.5 GHz band, and the 28 GHz band are used. With use of the fifth-generation (5G) wireless system, it becomes possible to obtain data and transmit the data to the medical institution 87, not only from home but also from the outside. As a result, data on poor physical conditions of the user can be accurately obtained and can be utilized for treatment performed later. Note that the portable data terminal 85 can have a structure illustrated in FIG. 14C.

FIG. 14C illustrates another example of a portable data terminal. A portable data terminal 89 includes a speaker, a pair of electrodes 83, a camera 84, and a microphone 86, in addition to a secondary battery.

The pair of electrodes 83 is provided in parts of a housing 82 with a display portion 81a therebetween. A display portion 81b is a curved region. The electrodes 83 function as electrodes for obtaining biological information.

Providing the pair of electrodes 83 in the longitudinal direction of the housing 82 as illustrated in FIG. 14C enables biological information to be obtained with the user being unconscious when the user uses the portable data terminal 89 with a landscape screen.

An example of the usage state of the portable data terminal 89 is illustrated. The display portion 81a can display electrocardiogram data 88a and heart-rate data 88b, which are obtained with the pair of electrodes 83.

This function is not necessary when the biosensor 80a is embedded in the user's body as illustrated in FIG. 14A. By contrast, when the biosensor 80a is not embedded, the user grasps the pair of electrodes 83 with the user's both hands, so that the electrocardiogram can be obtained. Even when the biosensor 80a is embedded in the user's body, the portable data terminal 89 illustrated in FIG. 14C can be used for comparing the electrocardiogram data with another user's in order to check whether the biosensor 80a operates normally.

The camera 84 can capture an image of the user's face, for example. Biological data on facial expression, a pupil, complexion, and the like can be obtained from the image of the user's face.

The microphone 86 can obtain the user's voice. Voiceprint data that can be used for voiceprint authentication can be obtained from the obtained voice data. When voice data is regularly obtained and a change in voice quality is monitored, the voice data can be utilized for health management. Needless to say, talking on a video call with a doctor at the medical institution 87 is possible with use of the microphone 86, the camera 84, and the speaker.

With use of the device illustrated in FIG. 14A and the portable data terminal 89 illustrated in FIG. 14C, a remote medical support system can be achieved, in which data is transmitted to a hospital in a remote area to see a doctor.

This embodiment can be implemented in appropriate combination with the other embodiments.

### Example 1

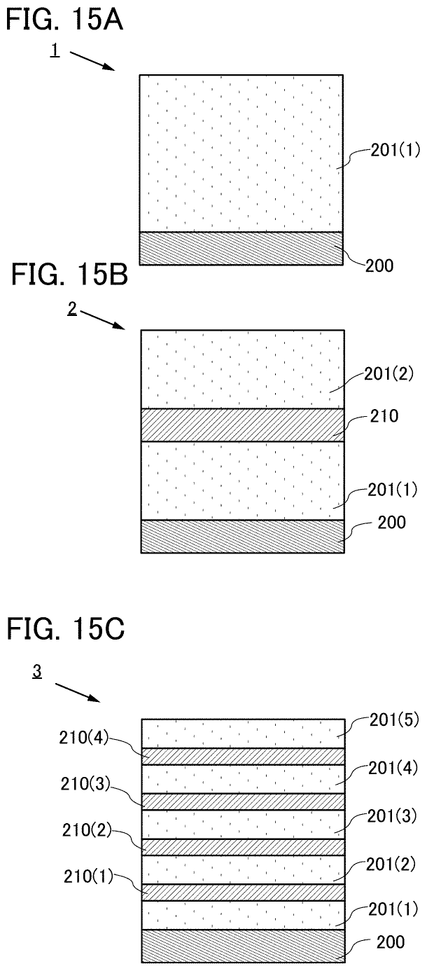

This example shows fabrication examples of secondary batteries including the negative electrodes of one embodiment of the present invention and a negative electrode which is a comparative example and the characteristics thereof. FIG. 15A to FIG. 15C and Table 1 show structures of the negative electrodes fabricated in this example. A comparative sample 1, which is a sample for comparison with the present invention, has a structure where the negative electrode active material layer consists of one layer. A sample 2, which is one embodiment of the present invention, includes two negative electrode active material layers and one separation layer. A sample 3, which is one embodiment of the present invention, includes five negative electrode active material layers and four separation layers. Each of the samples was fabricated such that the total thickness of an amorphous silicon (a-Si) layer, which was a negative electrode active material, was 100 nm.

TABLE 1

| | Comparative | | |
|---|---|---|---|
| | sample 1 | Sample 2 | Sample 3 |
| Negative electrode active | — | — | α-Si (20 nm) |
| material layer 201(5) | | | |
| Separation layer 210(4) | — | — | Ti (10 nm) |
| Negative electrode active | — | — | α-Si (20 nm) |
| material layer 201(4) | | | |
| Separation layer 210(3) | — | — | Ti (10 nm) |
| Negative electrode active | — | — | α-Si (20 nm) |
| material layer 201(3) | | | |
| Separation layer 210(2) | — | — | Ti (10 nm) |
| Negative electrode active | — | α-Si (50 nm) | α-Si (20 nm) |
| material layer 201(2) | | | |
| Separation layer 210(1) | — | Ti (20 nm) | Ti (10 nm) |
| Negative electrode active | α-Si (100 nm) | α-Si (50 nm) | α-Si (20 nm) |
| material layer 201(1) | | | |
| Substrate/negative electrode | Ti sheet | Ti sheet | Ti sheet |
| current collector layer 200 | | | |

### <Fabrication of Comparative Sample 1>

Amorphous silicon was deposited over a 100-μm thick titanium (Ti) sheet by a sputtering method to have the structure illustrated in FIG. 15A and the thickness and structure listed in Table 1.

### <Fabrication of Sample 2 and Sample 3>

Amorphous silicon and titanium were alternately deposited over a 100-μm thick titanium (Ti) sheet by a sputtering method to have the structures illustrated in FIG. 15B and FIG. 15C and the thickness and structures listed in Table 1.

### <Fabrication of Secondary Battery>

Next, CR2032 (diameter: 20 mm, height: 3.2 mm) coin-type secondary batteries were fabricated to examine charge and discharge characteristics of the samples obtained above. The secondary battery includes a positive electrode, a negative electrode, a separator, an electrolyte solution, a positive electrode can electrically connected to the positive electrode, and a negative electrode can electrically connected to the negative electrode.

A lithium metal was used for a counter electrode. A separator to be described later was sandwiched between the lithium and the negative electrode active material layer.

As an electrolyte contained in the electrolyte solution, 1 mol/L of lithium hexafluorophosphate (LiPF6) was used. As the electrolyte solution, an electrolyte solution in which ethylene carbonate (EC) and diethyl carbonate (DEC) were mixed at EC: DEC=3:7 (volume ratio) was used. Note that in the secondary battery whose charge and discharge characteristics were measured, 10 wt % of FEC (fluoroethylene carbonate) was added to the electrolyte solution.

As a separator, 25-μm-thick polypropylene was used.

A positive electrode can and a negative electrode can that were formed using stainless steel (SUS) were used.

### <Measurement of Cycle Performance>

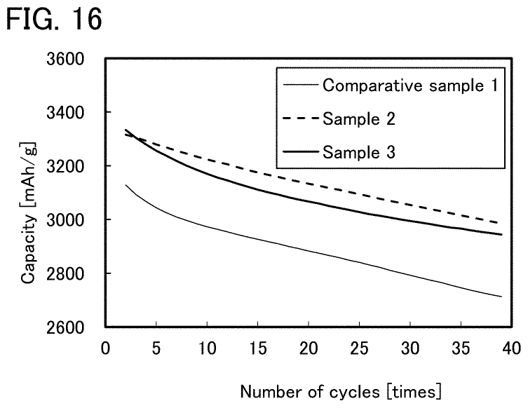

Next, the cycle performances of the fabricated secondary batteries were evaluated. First, the secondary batteries were measured at 25° C. for two cycles while the CCCV discharge (0.05 C, 4.6 V, a termination current of 0.005 C) and the CC charge (0.05 C, 2.5 V) were performed. These two cycles of the charging and discharging were not included in the number of times for measuring the cycle performances. After that, the CCCV discharging (0.2 C, 4.6 V, a termination current of 0.02 C) and the CC charging (0.2 C, 2.5 V) were repeatedly performed at 25° C., and then the cycle performance was evaluated. FIG. 16 shows the measurement results of the second and subsequent cycles. Since only the negative electrode is evaluated in this example, discharging refers to insertion of lithium ions into the negative electrode active material layer and charging refers to extraction of lithium ions from the negative electrode active material layer.

FIG. 16 reveals that the sample 2 and the sample 3 according to one embodiment of the present invention each have higher capacity than the comparative sample 1 and also have excellent cycle performance. The charge-discharge efficiency in the 39-th cycle of each of the sample 2 and the sample 3 is 89.0% while that of the comparative sample 1 is 86.7%. It is thus found that, when the negative electrode active material layer and the separation layer are alternately stacked, a secondary battery with high capacity, excellent cycle performance, and high charge-discharge efficiency can be fabricated.

### <Cross-Sectional STEM (Scanning Transmission Electron Microscope) Image>

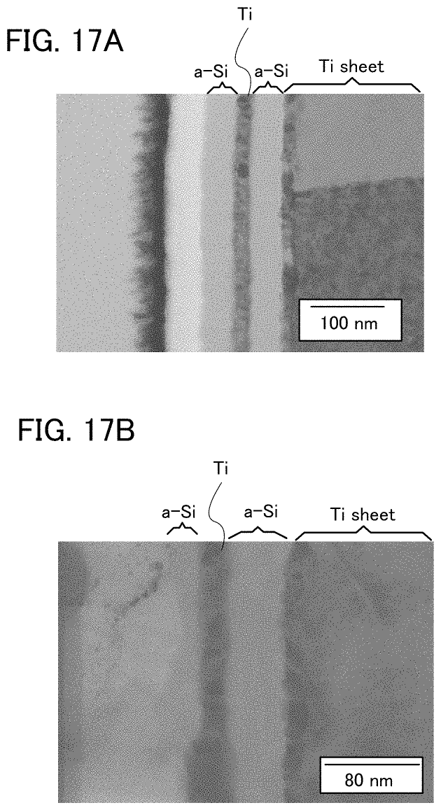

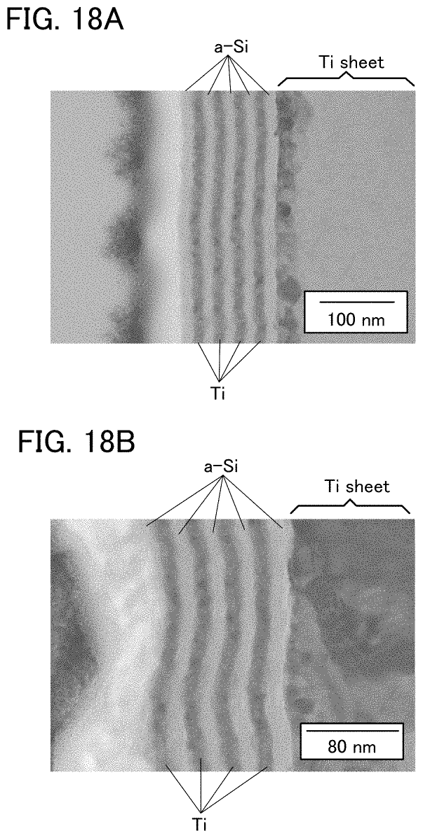

Next, FIG. 17A shows a cross-sectional STEM image of the sample 2 before charging and discharging, and FIG. 17B shows a cross-sectional STEM image after charging and discharging. FIG. 18A shows a cross-sectional STEM image of the sample 3 before charging and discharging, and FIG. 18B shows a cross-sectional STEM image after charging and discharging. FIG. 17A to FIG. 18B indicate that the film quality of each sample does not significantly change before and after charging and discharging. Thus, according to one embodiment of the present invention, a secondary battery with excellent cycle performance, high reliability, or a high level of safety can be fabricated.

### Example 2

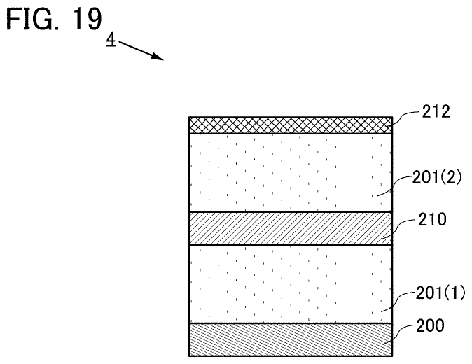

In this example, one embodiment of the present invention which has a structure different from that of the samples described in Example 1 is described. FIG. 19 and Table 2 show the structure of a negative electrode (sample 4) fabricated in this example. Over the negative electrode active material layer 201(2) of the sample 2, a Ti film is further included in the sample 4.

TABLE 2

| | Sample 4 |
|---|---|
| Ti film 212 | Ti (20 nm) |
| Negative electrode active material layer | α-Si (50 nm) |
| 201(2) | |
| Separation layer 210(1) | Ti (20 nm) |
| Negative electrode active material layer | α-Si (50 nm) |
| 201(1) | |
| Substrate/negative electrode current | Ti sheet |
| collector layer 200 | |

### <Fabrication of Sample 4>

Amorphous silicon and titanium were alternately deposited over a 100-μm thick titanium (Ti) sheet by a sputtering method to have the structure illustrated in FIG. 19 and the thickness and structures listed in Table 2.

### <Fabrication of Battery Cell>

Next, CR2032 (diameter: 20 mm, height: 3.2 mm) coin-type secondary battery was fabricated as in Example 1 to examine charge and discharge characteristics of the sample 4 obtained above.

### <Negative Electrode Before and After Charging and Discharging>

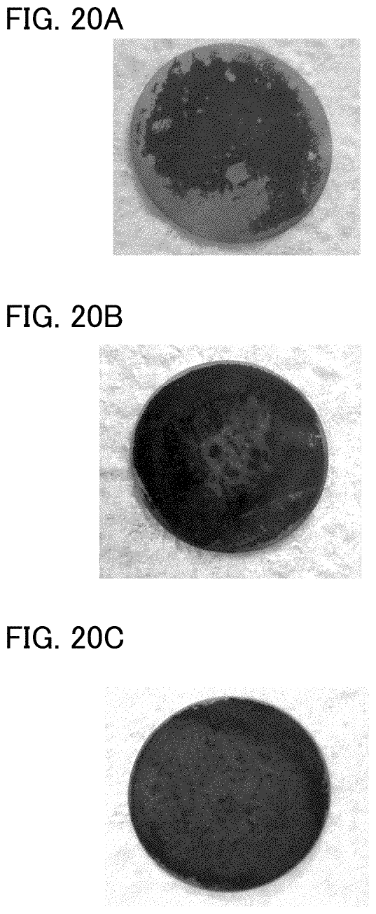

FIG. 20A to FIG. 20C show the states of the comparative sample 1, the sample 2, and the sample 4 after 40 charge and discharge cycles. FIG. 20A, FIG. 20B, and FIG. 20C show the states of the comparative sample 1, the sample 2, and the sample 4, respectively. The conditions for the charging and discharging are similar to those described in Example 1. In each photograph, the negative electrode active material layer is seen in black. A region seen in gray is a region where the negative electrode active material layer is peeled to expose the titanium sheet.

It is found that peeling of the negative electrode active material layer is more inhibited in FIG. 20B and FIG. 20C than that in FIG. 20A. This indicates that the cycle performance, reliability, or safety of the secondary battery can be improved according to one embodiment of the present invention. The comparison between FIG. 20B and FIG. 20C also shows that peeling of the negative electrode active material layer is more inhibited in FIG. 20C. This indicates that the cycle performance, reliability, or safety of the secondary battery can be improved by introduction of a film including Ti between the negative electrode active material layer and the electrolyte layer or the electrolyte solution.

### REFERENCE NUMERALS

80a: biosensor, 80b: biosensor, 81a: display portion, 81b: display portion, 82: housing, 83: electrode, 84: camera, 85: portable data terminal, 86: microphone, 87: medical institution, 88a: data, 88b: data, 89: portable data terminal, 101: substrate, 150: secondary battery, 152: secondary battery, 200: negative electrode current collector layer, 201: negative electrode active material layer, 202: solid electrolyte layer, 203: positive electrode active material layer, 205: positive electrode current collector layer, 206: protective layer, 210: separation layer, 211: solid electrolyte layer, 212: layer, 213: current collector layer, 215: current collector layer, 220(1): secondary battery, 220(2): secondary battery, 400: glasses-type device, 400a: frame, 400b: display portion, 401: headset-type device, 401a: microphone portion, 401b: flexible pipe, 401c: earphones portion, 402: device, 402a: housing, 402b: secondary battery, 403: device, 403a: housing, 403b: secondary battery, 405: watch-type device, 405a: display portion, 405b: belt portion, 406: belt-type device, 406a: belt portion, 406b: wireless power feeding and receiving portion, 511: negative electrode lead electrode, 513: positive electrode lead electrode, 700: portable information terminal, 701: housing, 702: display panel, 703: clasp, 705A: band, 705B: band, 711: operation button, 712: operation button, 750: secondary battery, 751: positive electrode lead, 752: negative electrode lead, 753: exterior body, 900: substrate, 911: terminal, 912: circuit, 913: secondary battery, 914: antenna, 916: layer, 951: terminal, 952: terminal, 971: terminal, 972: terminal, 3000: IC card, 3001: thin-film-type secondary battery, 3002: ID, 3003: image, 3004: IC, 3005: radio wave, 6300: cleaning robot, 6301: housing, 6302: display portion, 6303: camera, 6304: brush, 6305: operation button, 6310: dust, 6400: robot, 6401: illuminance sensor, 6402: microphone, 6403: upper camera, 6404: speaker, 6405: display portion, 6406: lower camera, 6407: obstacle sensor, 6408: moving mechanism, 6409: secondary battery, 6500: flying object, 6501: propeller, 6502: camera, 6503: secondary battery, 6504: electronic component, 7160: automobile, 7161: secondary battery

1. A negative electrode comprising, over a negative electrode current collector layer, n negative electrode active material layers and n−1 separation layers, where n is an integer greater than or equal to 2,
wherein the negative electrode active material layers and the separation layers are alternately stacked,
wherein a thickness of each of the n negative electrode active material layers is greater than or equal to 20 nm and less than 100 nm, and
wherein each of the separation layers comprises a Group 4 element.

2. A negative electrode comprising, over a negative electrode current collector layer, n negative electrode active material layers and n−1 separation layers, where n is an integer greater than or equal to 2,
wherein the negative electrode active material layers and the separation layers are alternately stacked,
wherein a thickness of each of the negative electrode active material layers is greater than or equal to 20 nm and less than 100 nm, and
wherein each of the separation layers comprises titanium nitride, titanium oxide, or titanium oxynitride.

3. The negative electrode according to claim 1,
wherein a first negative electrode active material layer is in contact with the negative electrode current collector layer.

4. The negative electrode according to claim 1,
wherein an i-th separation layer is in contact with an i-th negative electrode active material layer, where i is an integer greater than or equal to 1 and less than or equal to n−1.

5. The negative electrode according to claim 1, wherein a thickness of each of the n−1 separation layers is greater than or equal to 5 nm and less than or equal to 40 nm.

6. The negative electrode according to claim 1, further comprising:
a first layer over an n-th negative electrode active material layer.

7. The negative electrode according to claim 6, wherein the first layer comprises Ti.

8. The negative electrode according to claim 1, wherein each of the negative electrode active material layers comprises Si.

9. The negative electrode according to claim 1,
wherein the separation layers each have a layered structure.
